(19) United States
(12) Patent Application Publication
(10) Pub. No.: US 2022/0261691 A1
(43) Pub. Date: Aug. 18, 2022

(54) METHOD, DEVICE AND COMPUTER READABLE STORAGE MEDIUM FOR MODEL TRAINING AND DATA PROCESSING

(71) Applicant: NEC CORPORATION, Tokyo (JP)

(72) Inventors: Li QUAN, Beijing (CN); Ni Zhang, Beijing (CN)

(73) Assignee: NEC CORPORATION, Tokyo (JP)

(21) Appl. No.: 17/666,089

(22) Filed: Feb. 7, 2022

(30) Foreign Application Priority Data
Feb. 9, 2021 (CN) 202110179274.1

(51) Int. Cl. G06N 20/00; G06V 10/772

(52) U.S. Cl. CPC G06N 20/00; G06V 10/772

(57) ABSTRACT

The present disclosure relates to methods, devices and computer-readable storage media for model training and data processing. The method for model training comprises: determining respective degrees of influence of a plurality of augmented sample sets in a training set on a model to be trained, the plurality of augmented sample sets corresponding to a plurality of original samples; determining, based on the degrees of influence, a first group of augmented sample sets from the plurality of augmented sample sets, the first group of augmented sample sets being to have a negative influence on the model to be trained; determining a training loss function associated with the training set, in the training loss function, a first weight being allocated to augmented samples from the first group of augmented sample sets to reduce the negative influence; and training the model to be trained based on the training loss function and the training set. In this way, the performance of the trained model can be optimized.

### FIELD

Embodiments of the present disclosure relate to the field of data processing, and more specifically, to methods, devices and computer-readable storage media for model training and data processing.

### BACKGROUND

With the development of information technology, models such as neural networks are widely used in various machine learning tasks such as computer vision, speech recognition and information retrieval. The accuracy of the model is related to training data. In order to obtain a large amount of training data, the data augmentation technology has been used for processing the training data. However, conventionally, although the model may have good generalization performance by training the model with an augmented training set, there is a lack of analysis on the influence of individual sample data in the augmented training set on the accuracy of the model.

### SUMMARY

Embodiments of the present disclosure provide methods, devices and computer-readable storage media for model training and data processing.

In a first aspect of the present disclosure, a method for training model is provided. The method comprises: determining respective degrees of influence of a plurality of augmented sample sets in a training set on a model to be trained, the plurality of augmented sample sets corresponding to a plurality of original samples; determining, based on the degrees of influence, a first group of augmented sample sets from the plurality of augmented sample sets, the first group of augmented sample sets being to have a negative influence on the model to be trained; determining a training loss function associated with the training set, in the training loss function, a first weight being allocated to augmented samples from the first group of augmented sample sets to reduce the negative influence; and training the model to be trained based on the training loss function and the training set.

In a second aspect of the present disclosure, a method for data processing is provided. The method comprises: obtaining input data; and determining a prediction result for the input data by using a trained model trained by the method according to the first aspect of the present disclosure.

In a third aspect of the present disclosure, an electronic device is provided. The electronic device comprises at least one processing circuit. The at least one processing circuit is configured to: determine respective degrees of influence of a plurality of augmented sample sets in a training set on a model to be trained, the plurality of augmented sample sets corresponding to a plurality of original samples; determine, based on the degrees of influence, a first group of augmented sample sets from the plurality of augmented sample sets, the first group of augmented sample sets being to have a negative influence on the model to be trained; determine a training loss function associated with the training set, in the training loss function, a first weight being allocated to augmented samples from the first group of augmented sample sets to reduce the negative influence; and train the model to be trained based on the training loss function and the training set.

In a fourth aspect of the present disclosure, an electronic device is provided. The electronic device includes at least one processing circuit. The at least one processing circuit is configured to: obtain input data; and determine a prediction result for the input data by using a trained model trained by the method according to the first aspect of the present disclosure.

In a fifth aspect of the present disclosure, a computer-readable storage medium is provided. The computer-readable storage medium has machine-executable instructions stored thereon, and the machine-executable instructions, when executed by a device, causes the device to execute the method described in the first aspect of the present disclosure.

In a sixth aspect of the present disclosure, a computer-readable storage medium is provided. The computer-readable storage medium has machine-executable instructions stored thereon, and the machine-executable instructions, when executed by a device, causes the device to execute the method described in the second aspect of the present disclosure.

The Summary of the invention is provided to introduce a series of concepts in a simplified form, which will be further described in the following specific embodiments. The Summary of the invention is neither intended to identify key features or essential features of the present disclosure, nor intended to limit the scope of the present disclosure. Other features of the present disclosure will become understandable through the following description.

### BRIEF DESCRIPTION OF THE DRAWINGS

From the following disclosure and claims, the purposes, advantages and other features of the present disclosure will become more apparent. For the purpose of example only, a non-limiting description of preferred embodiments is given with reference to the drawings, in which:

FIG. 1A illustrates a schematic diagram of an example of a data processing environment in which some embodiments of the present disclosure can be implemented;

FIG. 1B illustrates a schematic diagram of an example of a training model environment in which some embodiments of the present disclosure can be implemented;

FIG. 2 illustrates a flow diagram of an example method for training a model according to some embodiments of the present disclosure;

FIG. 3 illustrates a schematic diagram of training a model based on degrees of influence according to some embodiments of the present disclosure;

FIG. 4 illustrates a schematic diagram of using pre-training to determine the degrees of influence and training the model accordingly according to some embodiments of the present disclosure;

FIG. 5 illustrates a flow diagram of an example method of data processing according to embodiments of the present disclosure;

FIG. 6 illustrates a schematic diagram of an example for representing the effectiveness of the degree of influence according to embodiments of the present disclosure; and

FIG. 7 illustrates a schematic block diagram of an example computing device that can be used for implementing an embodiment of the present disclosure.

In the various drawings, the same or corresponding reference numerals represent the same or corresponding parts.

### DETAILED DESCRIPTION OF EMBODIMENTS

Hereinafter, the embodiments of the present disclosure will be described in more detail with reference to the drawings. Although some embodiments of the present disclosure are shown in the drawings, it is to be understood that the present disclosure can be implemented in various forms and should not be construed as being limited to the embodiments set forth herein. On the contrary, these embodiments are provided for a more thorough and complete understanding of the present disclosure. It is to be understood that the drawings and embodiments of the present disclosure are only used for exemplary purposes, rather than limiting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “the embodiment” is to be read as “at least one example embodiment.” The terms “first”, “second” and so on can refer to same of different objects. The following description may also include other explicit and implicit definitions.

The term “circuitry” used herein may refer to hardware circuits and/or combinations of hardware circuits and software. For example, the circuitry may be a combination of analog and/or digital hardware circuit(s) with software/firmware. As another example, the circuitry may be any portions of hardware processor(s) with software (including digital signal processor(s)), software, and memory(ies) that work together to cause a device to perform various functions. In a further example, the circuitry may be hardware circuit(s) and or processor(s), such as a microprocessor(s) or a portion of a microprocessor(s), that requires software/firmware for operation, but the software may not be present when it is not needed for operation. The term “circuitry” used herein also covers an implementation of merely a hardware circuit or a processor, or a portion of a hardware circuit or a processor, and its (or their) accompanying software and/or firmware.

In the embodiments of the present disclosure, the term “model” can process an input and provide a corresponding output. Taking a neural network model as an example, it usually includes an input layer, an output layer, and one or more hidden layers between the input layer and the output layer. The model (also referred to as “deep learning model”) used in the deep learning applications usually includes a plurality of hidden layers to extend the depth of the network. Individual layers of the neural network model are connected in sequence, such that an output of a preceding layer is provided as an input for a following layer, where the input layer receives the input of the neural network while the output of the output layer acts as the final output of the neural network. Each layer of the neural network model includes one or more nodes (also referred to as processing nodes or neurons) and each node processes the input from the preceding layer. In the text, the terms “neural network,” “model,” “network” and “neural network model” may be used interchangeably.

As mentioned briefly above, the conventional solution lacks analysis on the influence of individual sample data in an augmented training set on the accuracy of the model. In practice, some data in the augmented training set may have a negative influence on the model. However, the conventional solution cannot distinguish the data with the negative influence in the augmented training set, and inhibit the negative influence on these data in a training process. Therefore, the accuracy of the model trained by such data is worse.

The inventors have discovered that, by discarding some augmented samples (for example, 200) that have negative influence (the specific evaluation method will be described in detail below) on the training of the model in the augmented training set, and then training the model, the accuracy of the trained model (for example, an image classification model) on (for example, classification) of a test set (for example, an MNIST-10 or CIFAR-10 data set, or a data subset selected therefrom) can be improved.

The embodiments of the present disclosure propose a solution for training model and data processing, to solve one or more of the above-mentioned problems and/or other potential problems. In this solution, for an augmented sample set of each sample in a training set, determine its degree of influence on a model to be trained, and determine, according to the degree of influence, whether the augmented sample set of each sample belongs to an augmented sample set harmful to the model. For the augmented sample set harmful to the model, the weights associated with samples in the augmented sample set in a training process and/or probabilities that the samples in the augmented sample set are selected for influence inhibition are adjusted. In this way, the performance of the trained model can be optimized, so that it has a good generalization performance, and meanwhile the accuracy is improved.

Hereinafter, exemplary embodiments of the present disclosure will be described in detail in combination with the drawings.

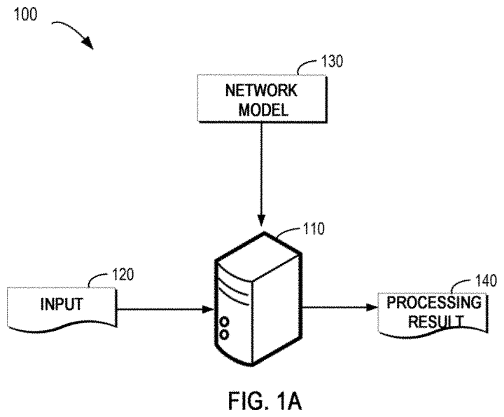

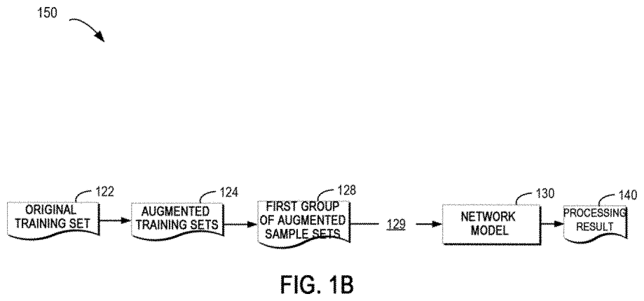

FIG. 1A illustrates a schematic diagram of an example of a data processing environment 100 in which some embodiments of the present disclosure can be implemented. As shown in FIG. 1A, the environment 100 comprises a computing device 110. The computing device 110 may be any device with computing capability, for example, a personal computer, a tablet computer, a wearable device, a cloud server, a mainframe, a distributed computing system, and so on.

The computing device 110 obtains an input 120. For example, the input 120 may be an image, a video, and/or a multimedia file, and so on. The computing device 110 may apply the input 120 to a network model 130, to generate a processing result 140 corresponding to the input 120 by using the network model 130. In some embodiments, the network model 130 may be, but is not limited to, an image classification model, a semantic segmentation model, a target detection model, or other neural network models related to image processing. The network model 130 may be implemented by using any suitable network structures, comprising, but not limited to, a support vector machine (SVM) model, a Bayesian model, a random forest model, various deep learning/neural network models, such as a convolutional neural network (CNN), a recurrent neural network (RNN), a deep neural network (DNN), and a deep reinforcement learning Network (DQN). The scope of the present disclosure is not limited in this respect.

The environment 100 may also comprise a training data obtaining apparatus, a model training apparatus and a model application apparatus (not shown). In some embodiments, the plurality of above apparatuses may be implemented in different physical computing devices, respectively. Alternatively, at least a part of the plurality of above apparatuses may be implemented in the same computing device. For example, the training data obtaining apparatus and the model training apparatus may be implemented in the same computing device, and the model application apparatus 150 may be implemented in another computing device.

In a model training stage, the training data obtaining apparatus may obtain the input 120 and provide it to the model. The input 120 may be one of: a training set, a validation set and a test set, and the network model 130 is a model to be trained. The model training apparatus may train the network model 130 based on the input. When the input is a training set, the processing result 140 may be to adjust training parameters (for example, weights and offsets or the like) of the network model 130, such that an error (which may be determined by a loss function) of the model on the training set is reduced.

When the input is a validation set, the processing result 140 may be to adjust hyperparameters (for example, a learning rate, network structure related parameters such as the number of layers) of the network model 130, so that the performance of the model on the validation set can be optimized. The processing result 140 may also be a representation of a performance indicator (for example, accuracy) of the trained network model 130, which may be represented by, for example, a verification loss. In the final stage of model training, the input may be a test set (which usually has more samples of various types than the validation set), and the processing result 140 may be a performance indicator (for example, accuracy) of the trained network model 130, which may be represented by, for example, a test loss.

An environment 150 for training the model is described in detail below with reference to FIG. 1B. The environment 150 may comprise an original training set 122 serving as the input 120, and the original training set 122 may comprise a plurality of original samples. In some embodiments, the sample may be image data. The computing device (for example, the training data obtaining apparatus of the computing device) may be configured to perform data augmentation processing on the original training set to obtain augmented training sets 124. The augmented training sets 124 (sometimes referred to as the training set herein) may comprise the above-mentioned plurality of original samples, and a plurality of augmented sample sets corresponding to the plurality of original samples, and the plurality of augmented sample sets corresponding to the plurality of original samples may be obtained by performing data augmentation processing on each of the plurality of original samples, respectively. In some embodiments, the augmented sample set corresponding to the original sample may not comprise the original sample itself. In some examples, for an image sample set, the augmented training set of images may be obtained by performing image cropping, rotation and flipping on the images therein. In some other examples, for the image sample set, the augmented training set of the images may be obtained by using an automatic sample augmentation strategy such as AutoAugment, wherein the automatic sample augmentation strategy comprises a group of optimized augmentation methods.

In the method discussed below, the computing device (for example, the training data obtaining apparatus of the computing device) may be configured to determine, for each augmented sample set in the plurality of augmented sample sets in the training sets 124, a corresponding degree of influence, and determine, from the plurality of augmented sample sets, a first group of augmented sample sets 128 that has a negative influence on the network model 130 to be trained. For example, by means of giving the first group of augmented sample sets 128 a weight capable of inhibiting their negative influence on the model 130 and/or adjusting the probabilities that the samples in the first group of augmented sample sets 128 are selected to implement influence inhibition, inhibition 129 on the negative influence of the first group of augmented sample sets 128 is implemented, and the network model 130 is trained accordingly to obtain the corresponding processing result 140.

In some embodiments, the degree of influence may be determined based on a difference between a first loss value and a second loss value as discussed in detail below. In some embodiments, the difference between the first loss value and the second loss value may be determined by an augmentation influence score (AIFS) of the augmented sample set as discussed in detail below. In other words, the degree of influence may also be based on AIFS.

Referring back to FIG. 1A, the trained network model may be provided for the model application apparatus. The model application apparatus may obtain the trained model and the input 120, and determine the processing result 140 for the input 120. In a model application stage, the input 120 may be input data (for example, image data) to be processed, the network model 130 is a trained model (for example, a trained image classification model), and the processing result 140 may be a prediction result (for example, an image classification result, a semantic segmentation result or a target recognition result) corresponding to the input 120 (for example, image data).

It is to be understood that, the environment 100 shown in FIG. 1A and the environment 150 shown in FIG. 1B are merely examples in which the embodiments of the present disclosure may be implemented, and are not intended to limit the scope of the present disclosure. The embodiments of the present disclosure are also applicable to other systems or architecture.

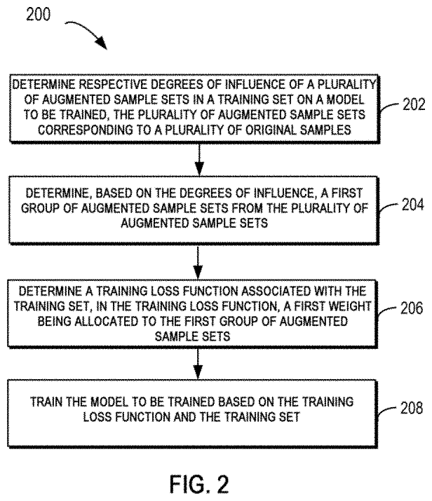

Hereinafter, the method according to the embodiments of the present disclosure will be described in detail in combination with FIGS. 2 to 5. For ease of understanding, specific data mentioned in the following description are all exemplary and are not used to limit the protection scope of the present disclosure. For ease of description, the method according to the embodiments of the present disclosure is described below in conjunction with the exemplary environments 100 and 150 shown in FIGS. 1A and 1B. The method according to the embodiments of the present disclosure may be implemented in the computing device 110 shown in FIG. 1A or other suitable devices. It is to be understood that, the method according to the embodiments of the present disclosure may further comprise additional actions not shown and/or the actions shown may be omitted, and the scope of the present disclosure is not limited in this respect.

FIG. 2 illustrates a flow diagram of an example method 200 for training a model according to the embodiments of the present disclosure. For example, the method 200 may be executed by the computing device 110 (for example, the model training apparatus deployed therein) as shown in FIG. 1A. The method 200 will be described below in conjunction with the exemplary environments of FIGS. 1A and 1B.

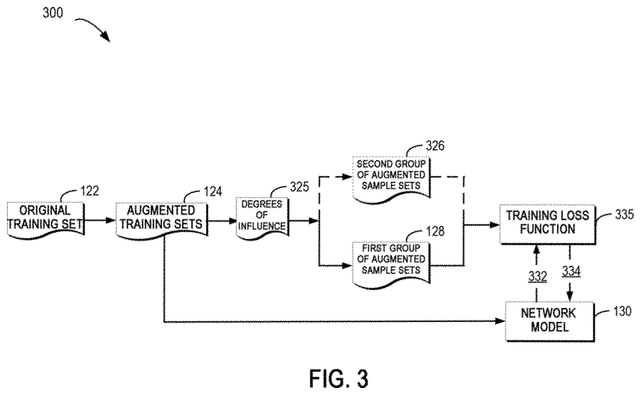

At block 202, the computing device 110 may determine respective degrees of influence of a plurality of augmented sample sets corresponding to a plurality of original samples in a training set on a model to be trained. For ease of description, a detailed explanation will be given below in conjunction with FIG. 3. FIG. 3 illustrates a schematic diagram 300 of training the model based on the degree of influence according to some embodiments of the present disclosure. Here, the training set 124 is augmented training sets 124 obtained by performing data augmentation processing on the original training set 122 that comprises the plurality of original samples. The augmented training sets 124 may comprise a plurality of original samples and a plurality of corresponding augmented sample sets, wherein each augmented sample set may be obtained by performing data augmentation processing on a corresponding original sample.

For each augmented sample set in the augmented training sets 124, the degree of influence 325 on the network model 130 (sometimes also referred to as the model to be trained 130 or the model 130) may be determined. Based on the determined degrees of influence, the samples in the augmented training sets 124 may be classified to serve as a basis for subsequent implementation of negative influence inhibition.

In some embodiments, the degrees of influence may be determined, for example, by the following steps of calculating the loss value. The computing device may determine the first loss value based on a first training subset of the training set 124, wherein the first training subset comprises only the plurality of original samples before the data augmentation processing. In some embodiments, the model 130 may be trained based on the first training subset of the training set, to obtain a group of optimization parameters, and the model 130 is updated based on the group of optimization parameters, to obtain an updated model using the group of optimization parameters. Then, the first loss value may be obtained by applying the validation set on the updated model.

The first loss value may be expressed as, for example, [symbol] ( [symbol] ᵥₐₗ; \hat{θ}( [symbol] ₜᵣₐᵢₙ)), where [symbol] represents the loss function; [symbol] ₜᵣₐᵢₙ represents the original training set 122 composed of the plurality of (for example, n) original samples, which may be further expressed as { [symbol] ᵢ=(xᵢ, [symbol] ᵢ)}ᵢ₌₁ⁿ⊂ [symbol] × [symbol] ; X represents the input, and Y represents the corresponding output; represents the validation set composed of a plurality of (for example, m) verification samples, which may be further expressed as [symbol] ᵥₐₗ={zⱼ=(xⱼ, [symbol] ⱼ)}ⱼ₌₁^{m}; and \hat{θ}( [symbol] ₜᵣₐᵢₙ) represents a group of optimization parameters, which may represent optimization parameters obtained by training the model based on the original training set (obviously, it is a subset of the augmented training set, that is, the first training subset), for example,

$$\hat{θ} ( {ℨ}_{train} ) := {argmin}_{θ} \frac{1}{n} {\sum }_{i}^{n} l ( {𝓏}_{i} ; θ ) ,$$

where argmin represents obtaining of a value when a subsequent expression reaches a minimum value θ.

The computing device 110 may determine the second loss value based on a second training subset of the training set 124. The second training subset may comprise the plurality of original samples and at least one augmented sample set in the plurality of augmented sample sets, and the at least one augmented sample set corresponds to at least one original sample in the plurality of original samples. In some embodiments, the second training subset may comprise an original sample and a corresponding augmented sample set, so that the augmented sample set having the negative influence on the model may be determined with finer granularity.

For example, the second training subset may comprise the original samples zl to zn, but it also comprises augmented sample sets that are obtained after the data augmentation processing is performed on one of the original samples. In other words, an original sample z in the original training set may be replaced with the following sample set [symbol] : [symbol] composed of a group of samples obtained after the data augmentation operation is performed on the original sample z.

In some embodiments, the model 130 may be trained based on the second training subset of the training set, to obtain another group of optimization parameters, and the model 130 is updated based on the other group of optimization parameters, to obtain an updated model using the other group of optimization parameters. Then, the second loss value may be obtained by applying the validation set on the updated model.

The second loss value may be expressed as, for example, [symbol] ( [symbol] ᵥₐₗ; [symbol] ), where the other group of optimization parameters is expressed as

$${\hat{ϑ} := {argmin}_{θ} ( \frac{1}{n} {\sum }_{i}^{n} l ( {𝓏}_{i} ; θ ) \}}_{𝓏 \vert {𝒯}_{𝓏}} ,$$

which may represent the optimization parameters obtained by training the model based on the second training subset as described above.

Based on the first loss value and the second loss value, the computing device may determine the degree of influence of the at least one augmented sample set on the model to be trained. It is to be understood that, although the influence of the augmented sample set on the model 130 is determined by calculating the loss value based on the validation set as described above, other approaches suitable for determining the first and second loss values of the trained model are also applicable.

At block 204, the computing device 110 may determine, based on the degrees of influence, the first group of augmented sample sets 128 from the plurality of augmented sample sets. The first group of augmented sample sets 128 has a negative influence on the model to be trained. Since an important indicator in the training process is the loss function, the training process is carried out toward a direction of reducing the value of the loss function. Therefore, it is possible to determine whether the degree of influence is the negative influence by comparing the first loss value and the second loss value determined above. In some embodiments, the degree of influence may be determined based on the following equation (1) in which the two loss values are subtracted:

[symbol]

( [symbol] )= [symbol] ( [symbol] ᵥₐₗ;\hat{θ}( [symbol] ₜᵣₐᵢₙ))− [symbol] ( [symbol] ᵥₐₗ; [symbol] ) Equation (1)

In the Equation (1), the degree of influence is indicated by a change in the verification loss (i.e., the loss on the validation set), in other words, it is indicated by the difference between the verification losses on two models that have been trained differently (for example, the training data are different). If it is determined that the result of the above Equation (1) is less than zero, at least one augmented sample set (for example, it may be indicated by [symbol] ) corresponding to at least one original sample may be determined to belong to the first group of augmented sample sets 128. This is because the training using the training set comprising the at least one augmented sample set corresponding to the at least one sample is carried out to cause the model to move in a direction in which the value of the loss function is increased. Therefore, such a sample set may be considered harmful to training the model 130.

In addition, or alternatively, if it is determined that the result of the above Equation (1) (i.e., the difference between the first loss value and the second loss value) is greater than or equal to zero, the at least one augmented sample set (for example, it may be indicated by) [symbol] ) corresponding to the at least one original sample may be determined to belong to a second group of augmented sample sets 326. The second group of augmented sample sets 326 will have positive influence on the model to be trained. This is because the training using the training set comprising the augmented sample set corresponding to the at least one sample is carried out to cause the model to move in a direction in which the value of the loss function decreases or does not change. Therefore, such a sample set may be considered beneficial for training the model 130.

At block 206, the computing device 110 may determine a training loss function 335 associated with the training set 124. In the training loss function, a first weight is allocated to the augmented samples from the first group of augmented sample sets 326, and the first weight may be any value that reduces the aforementioned negative influence. In some embodiments, the first weight may be a non-zero positive value. For the first group of augmented sample sets 128, since its influence on the model 130 is harmful, a lower first weight may be allocated to the first group of augmented sample sets 128. In some embodiments, the first weight may be adjusted according to the size of the degrees of influence. For example, for a sample with greater negative influence, the corresponding first weight may be made close to zero, thereby reducing its influence on the training loss function, and then better inhibition of the negative influence on the sample is realized.

The inventors found that, although it is possible to obtain better accuracy on the validation set by discarding the samples with the negative influence. However, the model obtained in this way may be able to obtain better accuracy for the validation set, but cannot achieve better results on such as test sets or real input data to be predicted. By means of the solution of applying weights to the samples with the negative influence instead of directly discarding these samples, the generalization ability of the trained model 130 can be made stronger.

In addition, or alternatively, in the training loss function, a second weight is allocated to the augmented samples from the second group of augmented sample sets 326, and the second weight being greater than or equal to the first weight. It is to be understood that, for the second group of augmented sample sets 326, because its influence on the model 130 is beneficial, so a higher second weight may be allocated to the second group of augmented sample sets 326, for example, a fixed value 1. In some embodiments, the second weight may be any value that makes the aforementioned positive influence unchanged or enhanced. For example, for a sample with greater positive influence, the respective second weight may be made greater.

At block 208, the computing device 110 may train the model to be trained based on the training loss function 335 and the training set 124.

For example, by means of forward propagation 332 and back propagation 334, a group of optimization parameters that minimize the training loss value of the training loss function 335 may be found. The above process may be performed iteratively, until the training loss value is less than a predetermined value.

In some embodiments, in order to further reduce the influence of negative samples and improve the accuracy, in each training batch, not all samples in the augmented training sets 124 may be inhibited. In some embodiments, a part of samples in the first group of augmented sample sets 128 may be randomly selected to construct a training subset, and a training loss function associated with the training subset is constructed. In some embodiments, it is possible to make the sample with the greater negative influence more likely to be selected, to realize better inhibition of such sample.

In addition, or alternatively, the training subset may comprise all or a part of samples in the second group of augmented sample sets 326. In some embodiments, for the selected part of samples, in the training loss function, a first weight less than the second weight may be allocated, and a first weight equal to the second weight may be allocated to other samples that are not selected.

In this way, the first group of augmented sample sets in the augmented training sets that has the negative influence on the training of the model may be determined, and inhibition of such negative influence may be easily applied, therefore the trained model may have better accuracy.

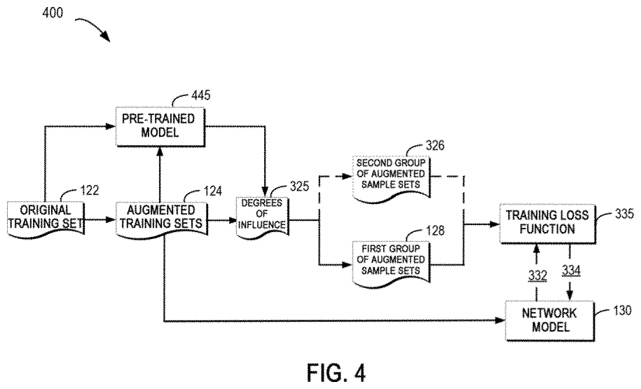

FIG. 4 illustrates a schematic diagram 400 of a process of using pre-training to determine the degrees of influence and training the model accordingly according to some embodiments of the present disclosure. The process shown in FIG. 4 is similar to the processes described above with reference to FIGS. 2 and 3, and only the parts that are different from the processes of FIGS. 2 and 3 will be described in detail below.

Specifically, since the calculation process of the above Equation (1) used for determining the degree of influence is relatively complicated, for example, for each original sample, it is necessary to train the model twice based on two different training sets, and respectively perform two instances of verification to determine two different loss values. Therefore, it is expected that the degree of influence may be determined in a simpler manner in which fewer computing resources are consumed. For example, it is expected that in a training process, the degree of influence may be determined for each original sample.

The inventors found that, the above-mentioned degree of influence may be determined in a simpler manner that is similar to determining an influence function of the influence of the sample by applying a slight perturbation to the sample. However, for an augmented sample set that comprises a plurality of augmented samples, how to apply the perturbation becomes a problem to be solved urgently.

To this end, the inventors define the following Equation (2), which represents an empirical risk minimization function for the second training subset (which comprises original samples and an augmented sample set corresponding to one original sample):

$$\hat{θ} ( ϵ , 𝒯 z \backslash z ) := arg {min}_{θ} \{ ϵ l ( 𝒯 z ; θ ) - ϵ l ( z ; θ ) + \frac{1}{n} {\sum }_{i}^{n} l ( {z}_{i} ; θ ) \} \qquad Equation ( 2 )$$

where ϵ [symbol] ( [symbol] ; θ)−ϵl( [symbol] ; θ) may represent the perturbation, and ϵ represents a minimum value, which is used for making the perturbation small. In the case of ϵ=1/n, the above Equation (2) may aim at the case where the training set comprises the original samples and the augmented sample set corresponding to one original sample (which may comprise the original sample itself), in other words, the case where the original sample is replaced with an augmented form of the original sample after data augmentation. Therefore, the influence after applying the above perturbation may be expressed as the following Equation (3):

$$\begin{matrix}\hat{θ} ( ϵ , 𝒯𝓏 \backslash 𝓏 ) - \hat{θ} ( {ℨ}_{train} ) = \frac{\partial \hat{θ} ( ϵ , 𝒯𝓏 \backslash 𝓏 )}{\partial ϵ} {\vert}_{ε = 0} \\ = {H}_{\hat{θ} ( {ℨ}_{train} )}^{- 1} [ {∇}_{θ} l ( 𝓏 ; \hat{θ} ( {ℨ}_{train} ) ) - \\ {∇}_{θ} l ( 𝒯𝓏 ; \hat{θ} ( {ℨ}_{train} ) ) ]\end{matrix} \qquad ( 3 )$$

where H represents a Hessian matrix.

Further, the above Equation (3) may be further simplified into the following Equation (4) by using ϵ=1/n and linear approximation, to express a change in the optimization parameters caused by the above replacement:

$$\hat{θ} ( \frac{1}{n} , 𝒯𝓏 \backslash 𝓏 ) - \hat{θ} ( {ℨ}_{train} ) \approx \frac{1}{n} [ \hat{θ} ( ϵ , 𝒯𝓏 \backslash 𝓏 ) - \hat{θ} ( {ℨ}_{train} ) ] = \frac{1}{n} {H}_{\hat{θ} ( {ℨ}_{train} )}^{- 1} [ {∇}_{θ} l ( 𝓏 ; \hat{θ} ( {ℨ}_{train} ) ) - {∇}_{θ} l ( 𝒯𝓏 ; \hat{θ} ( {ℨ}_{train} ) ) ] \qquad ( 4 )$$

Based on the perturbation mentioned above, the change in the verification loss represented by the Equation (1) may be expressed as a change in the verification loss caused by the replacement of an original sample in the original training set with its augmented form (for example, in the case of ϵ=1/n). Therefore, on the basis of the Equation (4), the difference between the loss values in the Equation (1) maybe approximately expressed by the following Equation (5):

$$\begin{matrix}𝒜ℐℱ𝒮 ( 𝒯𝓏 ) := - \frac{1}{m} {\sum }_{j}^{m} [ l ( {𝓏}_{j} ; \hat{θ} ( \frac{1}{n} , 𝒯𝓏 \backslash 𝓏 ) - l ( {𝓏}_{j} ; \hat{θ} ( {ℨ}_{train} ) ] \\ {\approx - \frac{1}{n} \frac{\partial }{\partial ϵ} \{ \frac{1}{m} {\sum }_{j}^{m} [ l ( {𝓏}_{j} ; \hat{θ} ( ϵ , 𝒯𝓏 \backslash 𝓏 ) \} \vert}_{ϵ = 0} \\ = - \{ \frac{1}{m} {\sum }_{j}^{m} {∇}_{θ} {l ( {𝓏}_{j} ; \hat{θ} ( {ℨ}_{train} ) )}^{T} \} {H}_{\hat{θ} ( {ℨ}_{train} )}^{- 1} \\ \{ \frac{1}{n} [ {∇}_{θ} l ( 𝓏 ; \hat{θ} ( {ℨ}_{train} ) ) - {∇}_{θ} l ( 𝒯𝓏 ; \hat{θ} ( {ℨ}_{train} ) ) ] \}\end{matrix} \qquad ( 5 )$$

wherein, AIFS represents, on m validation samples, an augmentation influence score of the augmented sample set [symbol] on the model 30, and the right side of the above Equation (5) is approximated by first-order Taylor expansion. The size of the AIFS score may comprise the size of the positive influence or the negative influence of the augmented sample set [symbol] on the model 30 on the m verification samples.

It can be seen from the right side of the Equation (5) that, a group of optimization parameters \hat{θ}( [symbol] ₜᵣₐᵢₙ) is only related to the original training set [symbol] ₜᵣₐᵢₙ composed of the original samples, and therefore, only once training is required to obtain the group of optimization parameters.

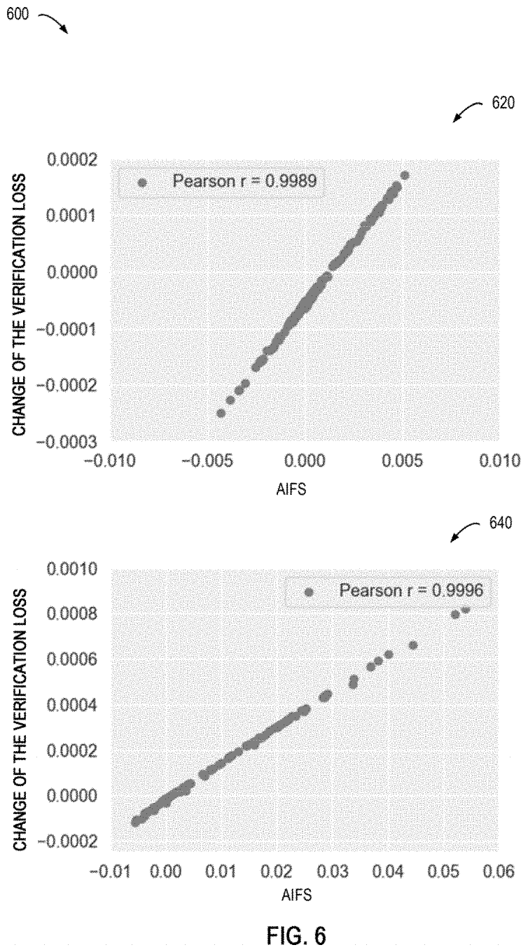

Now the degree of closeness between the above Equation (5) and the Equation (1) will be illustrated with reference to FIG. 6. FIG. 6 illustrates a schematic diagram of an example 600 for representing the effectiveness of the degree of influence according to embodiments of the present disclosure. As shown in FIG. 6, a point diagram 620 and a point diagram 640 respectively represent, on an MNIST-2 data set and a CIFAR-2 data set, the relationship between the AIFS of the plurality of augmented sample sets obtained according to the method mentioned above and the change in the respective verification loss, and each change in the verification loss is obtained by subtracting the losses obtained in the two training processes, wherein the first training process is performed based on a training set containing only the original samples, and the second training is performed based on a training set obtained by replacing a sample in the original samples with an augmented form of the sample. It can be seen from the figure that, for the MNIST-2 data set, the Pearson correlation coefficient (Pearson r) therebetween (that is, between the AIFS and the change in the verification loss) is 0.9989, and for the CIFAR-2 data set, the Pearson correlation coefficient therebetween (that is, between the AIFS and the change in the verification loss) is 0.9996. Thus it can be seen that, the AIFS in the Equation (5) proposed in the present disclosure can well represent the degree of influence determined by subtracting the two loss values in the equation (1). Therefore, in some embodiments, the degree of influence (for example, the difference between the first loss value and the second loss value) may also be determined by calculating the AIFS.

Referring back to FIG. 4, on this basis, the computing device 120 may determine, at least based on a pre-trained model 445 related to a model to be trained 300, at least one original sample (for example, 1) in the original training set 122, and at least one respective augmented sample set (for example, 1) in the augmented training sets 124, the result (i.e., the AIFS) of the Equation (5), and then determine a degree of influence 325. The result of the Equation (5) is appropriately the same as that of the above Equation (1). Therefore, the difference between the first loss value and the second loss value may be determined by using the result of the Equation (5).

It can be known from the above formula that, the pre-trained model 445 is trained using only the original training set 122 composed of a plurality of original samples, and a group of optimization parameters \hat{θ}( [symbol] ₜᵣₐᵢₙ) is obtained accordingly. Thus, the computing device may calculate the difference of terms ∇_{θ} [symbol] ( [symbol] ; \hat{θ}( [symbol] ₜᵣₐᵢₙ))−∇_{θ} [symbol] ( [symbol] ; \hat{θ}( [symbol] ₜᵣₐᵢₙ)) in the above Equation (5), and then determine the result of the Equation (5).

In this way, the calculation process for determining the degrees of influence can be simplified. For example, it is only necessary to use the original training set 122 to train the pre-trained model 445 once. As a result, the computational overhead for determining the first group of augmented sample sets 128 can be reduced.

In some embodiments, the AIFS used for indicating the degree of influence 325 may be further determined based on the Hessian matrix. Considering that the calculation of the Hessian matrix related to a group of optimization parameters in the above Equation (5) still has relatively large computational overhead, in some embodiments, the Hessian matrix may be predetermined by using the pre-trained model 445 and stored in a storage apparatus. In some embodiments, the items

$$- \{ \frac{1}{m} {\sum }_{j}^{m} {∇}_{θ} {l ( {𝓏}_{j} ; \hat{θ} ( {ℨ}_{train} ) )}^{T} \} {H}_{\hat{θ} ( {ℨ}_{train} )}^{- 1}$$

related to the Hessian matrix in the Equation (5) may be approximately calculated by an implicit Hessian-vector product (implicit Hessian-vector product, HVP). The stored calculated values related to the Hessian matrix may be subsequently read for use in the subsequent process of using the pre-trained model. In this way, the computational overhead required in real-time in the training process can be further reduced.

Based on the AIFS of each augmented sample set determined above, the augmented sample set with AIFS less than 0 may be determined to belong to the first group of augmented sample sets 128 (which can be expressed as Hₙ), that is, an augmented sample set with the negative influence. In addition, or alternatively, an augmented sample set with AIFS greater than or equal to 0 may be determined to belong to the second group of augmented sample sets 326 (which can be expressed as Hₚ), that is, an augmented sample set with the positive influence.

In some embodiments, for the process of training the model to be trained with reference to FIG. 2 as described above, the present embodiment can further include the following step of selecting a training sample on which influence inhibition will be implemented. For example, the computing device may determine, on the basis of the determined degrees of influence (for example, the AIFSs), probabilities that individual augmented samples in the first group of augmented sample sets 128 are selected. The probabilities may be used for representing the probabilities that predetermined samples are selected as samples in the training subset in each training batch (batch). For each training batch, the computing device determines a training subset from the training set 124 based on the aforementioned probabilities to construct a training loss function 335 associated therewith based on the training subset. Then, the computing device may train the model to be trained 130 toward a direction of minimizing the training loss function 335.)

For example, a variable [symbol] ₖ obeying the Bernoulli distribution [symbol] (pₖ) may be used for selecting a sample that needs to be inhibited in the first group of augmented sample sets 128, wherein

$${p}_{k} = \frac{\vert 𝒜ℐℱ𝒮 ( {𝒯𝓏}_{k} ) \vert}{{max}_{𝓏 ∈ {H}_{n}} ( 𝒜ℐℱ𝒮 ( 𝒯𝓏 ) )} ,$$

that is, a ratio of an absolute value of the AIFS of a specific sample Zk to the absolute value of the largest AIFS in the AIFS values of all samples in Hₙ, and the probability that the sample in Hₙ is selected satisfies the following Equation (6):

$$\{ \begin{matrix}P ( {S}_{k} = 1 ) = {p}_{k} \\ P ( {S}_{k} = 0 ) = 1 - {p}_{k}\end{matrix} \qquad ( 6 )$$

Therefore, the smaller the AIFS (a negative value) is, the greater the pk is, and the greater the probability of [symbol] ₖ=1 is, which indicates that the sample is easier to be selected, and vice versa.

Based on the training sample selected in the above manner, the training loss function 335 may be constructed in the following method. For example, for the foregoing training subset, the computing device 110 may determine the first weight based on the above probabilities, and may allocate the above first weight to the corresponding selected augmented sample from the first group of augmented sample sets 128. For example, when the AIFS of a specific augmented sample set is smaller (a negative value), the greater the pk is, the greater the probabilities that samples in the specific augmented sample set are selected are, and when the samples are selected, the first weight is correspondingly smaller. In some embodiments, for the above training subset, the second weight of the corresponding augmented sample from the second group of augmented sample sets 326 may be 1.

In some embodiments, a training loss function (LHASI) inhibited by a harmful augmented sample set and represented by the following Equation (7) may be constructed as the training loss function 335:

$${L}_{HASI} ( {ℨ}_{train} ) = \frac{1}{n} [ {\sum }_{{𝓏}_{t} ⊂ {H}_{p}} {l}_{c} ( {𝓏}_{t} ) + {\sum }_{{𝓏}_{k} ⊂ {H}_{n}} ( 1 - {S}_{k} \times {p}_{k} ) {l}_{c} ( {𝓏}_{k} ) ] \qquad ( 7 )$$

For example, by means of the forward propagation 332 and the back propagation 334, a group of optimization parameters that minimize the value of the Equation (7) may be found. The above process may be performed iteratively, until the training loss value is less than a predetermined value. It is to be understood that, although it is taken as an example above for description that the samples are selected by means of the Bernoulli distribution and the variables associated therewith, and the respective training loss function is constructed, other similar distributions may also be applied to the present disclosure, and the present disclosure is not limited herein.

According to the present embodiment, the degrees of influence of the augmented sample set may be determined by consuming computing resources, then the augmented samples with the negative influence can be inhibited, and thus the trained model can have better accuracy.

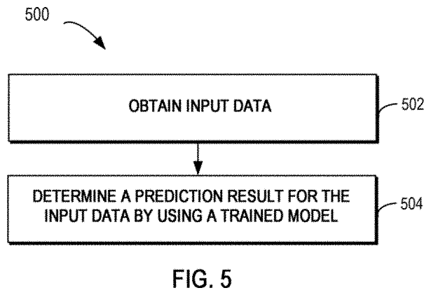

FIG. 5 illustrates a flow diagram of an example method 500 of model training and data processing according to embodiments of the present disclosure. For example, the method 500 may be executed by the computing device as shown in FIG. 1A.

At block 502, the computing device 110 may obtain input data. The computing device 110 may be deployed with a trained model trained in the manner described above. In some embodiments, the input data may be image data to be performed an image classification, and the trained model is one of an image classification model, a semantic segmentation model and a target recognition model.

At block 504, the computing device 110 may determine a prediction result for the input data by using the trained model. For example, in embodiments in which the above input data may be image data to be performed an image classification and the trained model is an image classification model, the prediction result is an image classification result. In embodiments in which the above input data may be image data to be performed a semantic segmentation and the trained model is a semantic segmentation model, the prediction result is a semantic segmentation result. In embodiments in which the above input data may be image data to be performed target recognition and the trained model is a target recognition model, the prediction result is a target recognition result. The solution according to the present disclosure may also be applied to other tasks related to image processing or tasks performed based on image processing technology (for example, autonomous driving, autonomous parking, and so on).

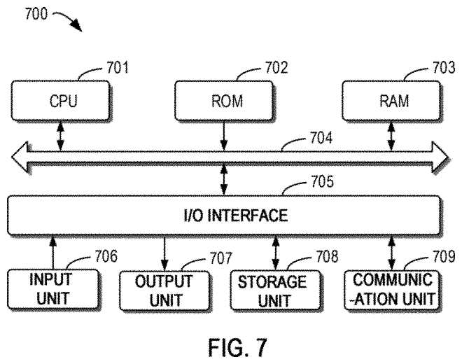

FIG. 7 illustrates a schematic block diagram of an exemplary computing device 700 that may be used for implementing embodiments of the present disclosure. For example, one or more apparatuses in the system 100 as shown in FIG. 1A may be implemented by the device 700. As shown in the figure, the device 700 comprises a central processing unit (CPU) 701, which may execute various appropriate actions and processing according to computer program instructions stored in a read-only memory (ROM) 702 or computer program instructions loaded from a storage unit 708 into a random access memory (RAM) 703. In the RAM 703, there are also stored various programs and data required by the device 600 when operating. The CPU 701, the ROM 702 and the RAM 703 are connected to each other through a bus 704. An input/output (I/O) interface 705 is also connected to the bus 704.

A plurality of components in the device 700 are connected to the I/O interface 705, comprising: an input unit 706, such as a keyboard, a mouse or the like; an output unit 707, such as various types of displays, loudspeakers or the like; a storage unit 708, such as a magnetic disk, an optical disk or the like; and a communication unit 709, such as a network card, a modem, a wireless communication transceiver or the like. The communication unit 709 allows the device 700 to exchange information/data with other devices through computer networks such as the Internet and/or various telecommunication networks.

The processing unit 701 may be configured to execute the various processes and processing described above, such as the methods 200 and 500. For example, in some embodiments, the methods 200 and 500 may be implemented as computer software programs, which are tangibly contained in a machine-readable medium, such as the storage unit 708. In some embodiments, a part or all of the computer programs may be loaded and/or installed on the device 700 via the ROM 702 and/or the communication unit 709. When the computer programs are loaded into the RAM 703 and executed by the CPU 701, one or more steps in the methods 200 and 500 described above may be executed.

In some embodiments, the electronic device comprises at least one processing circuit. The at least one processing circuit is configured to execute one or more steps in the methods 200 and 500 described above.

The present disclosure may be implemented as a system, a method and/or a computer program product. When the present disclosure is implemented as a system, apart from being integrated on an individual device, the components described herein may also be implemented in the form of a cloud computing architecture. In a cloud computing environment, these components may be remotely arranged and may cooperate to realize the functions described in the present disclosure. Cloud computing may provide computation, software, data access and storage services without informing a terminal user of physical locations or configurations of systems or hardware providing such services. The cloud computing may provide services over a wide area network (such as the Internet) by using appropriate protocols. For example, cloud computing providers provide, through the wide area network, the applications may be accessed through a browser or any other computing components. Cloud computing components and corresponding data may be stored on a remote server. Computing resources in the cloud computing environment may be merged at a remote data center location, or these computing resources may be dispersed. Cloud computing infrastructure may provide services through a shared data center, even if they appear to be a single access point for users. Therefore, various functions described herein may be provided from a remote service provider by using the cloud computing architecture. Alternatively, they may be provided from a conventional server, or they may be installed on a client device directly or in other ways. In addition, the present disclosure may further be implemented as a computer program product, and the computer program product may comprise a computer-readable storage medium on which computer-readable program instructions for executing various aspects of the present disclosure are loaded.

The computer-readable storage medium can be a tangible device that can hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the above devices. A non-exhaustive list of more specific examples of the computer-readable storage medium includes the following: a portable computer disk, a hard disk, a random access memory (RAM), a read-only memory (ROM), an erasable programmable read-only memory (EPROM or a flash memory), a static random access memory (SRAM), a portable compact disk read-only memory (CD-ROM), a digital versatile disk (DVD), a memory stick, a floppy disk, a mechanical encoding device, such as a protruding structure in a punch card or a groove on which instructions are stored, and any suitable combination of the above devices. The computer-readable storage medium used here is not interpreted as a transient signal itself, such as radio waves or other freely propagating electromagnetic waves, electromagnetic waves propagating through waveguides or other transmission media (for example, light pulses transmitted via optical fiber cables), or electrical signals transmitted via electric wires.

The computer-readable program instructions described herein can be downloaded from the computer-readable storage medium into various computing/processing devices, or downloaded into an external computer or external storage device via a network, such as the Internet, a local area network, a wide area network, and/or a wireless network. The network can include a copper transmission cable, optical fiber transmission, wireless transmission, a router, a firewall, a switch, a gateway computer, and/or an edge server. A network adapter card or network interface in each computing/processing device receives the computer-readable program instructions from the network, and forwards the computer-readable program instructions for storage in the computer-readable storage medium in each computing/processing device.

The computer program instructions used for executing the operations of the present disclosure can be assembly instructions, instruction set architecture (ISA) instructions, machine instructions, machine-related instructions, microcode, firmware instructions, state setting data, or source codes or target codes compiled in any combination of one or more programming languages, the programming languages include object-oriented programming languages such as Smalltalk and C++, and conventional procedural programming languages such as “C” programming language or similar programming languages. The computer-readable program instructions can be completely executed on a user computer, partly executed on the user computer, executed as a stand-alone software package, partly executed on the user computer and partly executed on a remote computer, or completely executed on a remote computer or a server. In the case where the remote computer is involved, the remote computer can be connected to the user computer through any kind of networks, including a local area network (LAN) or a wide area network (WAN), or it can be connected to an external computer (for example, connected via the Internet by using an Internet service provider). In some embodiments, an electronic circuit, such as a programmable logic circuit, a field programmable gate array (FPGA) or a programmable logic array (PLA), can be customized by using the state information of the computer-readable program instructions. The electronic circuit can execute the computer-readable program instructions to realize various aspects of the present disclosure.

Here, various aspects of the present disclosure are described with reference to flow diagrams and/or block diagrams of the method, the apparatus (system) and the computer program product according to the embodiments of the present disclosure. It is to be understood that, each block of the flow diagrams and/or the block diagrams and combinations of blocks in the flow diagrams and/or the block diagrams can be implemented by the computer-readable program instructions.

These computer-readable program instructions can be provided for a general-purpose computer, a special-purpose computer or processing units of other programmable data processing apparatuses to generate a machine, such that these instructions, when executed by the computers or the processing units of the other programmable data processing apparatuses, generate apparatuses used for realizing specified functions/actions in one or more blocks of the flow diagrams and/or the block diagrams. These computer-readable program instructions can also be stored in the computer-readable storage medium, these instructions cause the computer, the programmable data processing apparatuses and/or other devices to work in particular manners, such that the computer-readable storage medium storing the instructions includes a product, which includes instructions for realizing various aspects of the specified functions/actions in one or more blocks of the flow diagrams and/or the block diagrams.

These computer-readable program instructions can also be loaded on the computers, the other programmable data processing apparatuses or the other devices to execute a series of operation steps on the computers, the other programmable data processing apparatuses or the other devices to produce processes realized by the computers, such that the instructions executed on the computers, the other programmable data processing apparatuses or the other devices realize the specified functions/actions in one or more blocks of the flow diagrams and/or the block diagrams.

The flow diagrams and the block diagrams in the drawings show system architectures, functions and operations that can be implemented by the system, the method and the computer program product according to a plurality of embodiments of the present disclosure. In this regard, each block in the flow diagrams and the block diagrams can represent a part of a module, a program segment or an instruction, and the part of the module, the program segment or the instruction contains one or more executable instructions for realizing specified logical functions. In some alternative implementations, the functions marked in the blocks can also occur in a different order from the order marked in the drawings. For example, two consecutive blocks can actually be executed substantially in parallel, or they can sometimes be executed in a reverse order, depending on the functions involved. It is also to be noted that, each block in the block diagrams and/or the flow diagrams, and the combination of the blocks in the block diagrams and/or the flow diagrams can be implemented by a dedicated hardware-based system that is used for executing the specified functions or actions, or it can be implemented by a combination of dedicated hardware and computer instructions.

The various embodiments of the present disclosure have been described above, and the above description is exemplary, not exhaustive, and is not limited to the various disclosed embodiments. Without departing from the scope and spirit of the various described embodiments, many modifications and changes are obvious to those of ordinary skill in the art. The terminology used herein was chosen to best explain the principles of various embodiments, practical applications, or improvements to the technology in the market, or to enable other ordinary skilled in the art to understand the various embodiments disclosed herein.

1. A method for data processing, comprising:
determining respective degrees of influence of a plurality of augmented sample sets in a training set on a model to be trained, the plurality of augmented sample sets corresponding to a plurality of original samples;
determining, based on the degrees of influence, a first group of augmented sample sets from the plurality of augmented sample sets, the first group of augmented sample sets being to have a negative influence on the model to be trained;
determining a training loss function associated with the training set, in the training loss function, a first weight being allocated to augmented samples from the first group of augmented sample sets to reduce the negative influence; and
training the model to be trained based on the training loss function and the training set.

2. The method according to claim 1, wherein determining the degrees of influence of the plurality of augmented sample sets on the model to be trained comprises:
determining a first loss value based on a first training subset of the training set, the first training subset comprising only the plurality of original samples;
determining a second loss value based on a second training subset of the training set, the second training subset comprising the plurality of original samples and at least one augmented sample set of the plurality of augmented sample sets, the at least one augmented sample set corresponding to at least one original sample of the plurality of original samples; and
determining a degree of influence of the at least one augmented sample set on the model to be trained based on the first loss value and the second loss value.

3. The method according to claim 2, wherein determining the first group of augmented sample sets further comprises:
in accordance with a determination that a difference between the first loss value and the second loss value is less than zero, determining the at least one augmented sample set to belong to the first group of augmented sample sets; and
in accordance with a determination that the difference between the first loss value and the second loss value is greater than or equal to zero, determining the at least one augmented sample set to belong to a second group of augmented sample sets, the second group of augmented sample sets being to have a positive influence on the model to be trained.

4. The method according to claim 3, wherein determining the difference comprises:
determining the difference at least based on a pre-trained model related to the model to be trained, the at least one original sample and the at least one augmented sample set, the pre-trained model being trained using only the plurality of original samples.

5. The method according to claim 4, wherein determining the difference at least based on the pre-trained model related to the model to be trained, the at least one original sample and the at least one augmented sample set further comprises:
determining the difference based on a Hessian matrix, the Hessian matrix being predetermined by using the pre-trained model.

6. The method according to claim 1, wherein training the model to be trained comprises:
determining, based on the degrees of influence, probabilities that individual augmented samples in the first group of augmented sample sets are selected;
determining a training subset from the training set and based on the probabilities; and
training the model to be trained at least based on the training loss function associated with the training subset.

7. The method according to claim 6, wherein determining the training loss function further comprises:
for an augmented sample from the first group of augmented sample sets in the training subset, determining the first weight based on the probabilities.

8. The method according to claim 1, further comprising:
obtaining input data; and
determining a prediction result for the input data by using the trained model.

9. The method according to claim 8, wherein the input data is data of an image, the trained model is one of: an image classification model, a semantic segmentation model and a target recognition model, and the prediction result is a corresponding one of: an image classification result, a semantic segmentation result and a target recognition result.

10. An electronic device, comprising:
at least one processing circuit configured to:
determine respective degrees of influence of a plurality of augmented sample sets in a training set on a model to be trained, the plurality of augmented sample sets corresponding to a plurality of original samples;
determine, based on the degrees of influence, a first group of augmented sample sets from the plurality of augmented sample sets, the first group of augmented sample sets being to have a negative influence on the model to be trained;
determine a training loss function associated with the training set, in the training loss function, a first weight being allocated to augmented samples from the first group of augmented sample sets to reduce the negative influence; and
train the model to be trained based on the training loss function and the training set.

11. The device according to claim 10, wherein the at least one processing circuit is further configured to:
determine a first loss value based on a first training subset of the training set, the first training subset comprising only the plurality of original samples;
determine a second loss value based on a second training subset of the training set, the second training subset comprising the plurality of original samples and at least one augmented sample set of the plurality of augmented sample sets, the at least one augmented sample set corresponding to at least one original sample of the plurality of original samples; and
determine a degree of influence of the at least one augmented sample set on the model to be trained based on the first loss value and the second loss value.

12. The device according to claim 11, wherein the at least one processing circuit is further configured to:
in accordance with a determination that a difference between the first loss value and the second loss value is less than zero, determine the at least one augmented sample set to belong to the first group of augmented sample sets; and
in accordance with a determination that the difference between the first loss value and the second loss value is greater than or equal to zero, determine the at least one augmented sample set to belong to a second group of augmented sample sets, the second group of augmented sample sets being to have a positive influence on the model to be trained.

13. The device according to claim 11, wherein the at least one processing circuit is further configured to:
determine the difference at least based on a pre-trained model related to the model to be trained, the at least one original sample and the at least one augmented sample set, the pre-trained model being trained using only the plurality of original samples.

14. The device according to claim 13, wherein the at least one processing circuit is further configured to:
determine the difference based on a Hessian matrix, the Hessian matrix being predetermined by using the pre-trained model.

15. The device according to claim 10, wherein the at least one processing circuit is further configured to:
determine, based on the degrees of influence, probabilities that individual augmented samples in the first group of augmented sample sets are selected;
determine a training subset in the training set based on the probabilities; and
train the model to be trained at least based on the training loss function associated with the training subset.

16. The device according to claim 15, wherein the at least one processing circuit is further configured to:
for an augmented sample from the first group of augmented sample sets in the training subset, determine the first weight based on the probabilities.

17. The device according to claim 10, wherein the at least one processing circuit is further configured to:
obtain input data; and
determine a prediction result for the input data by using the trained model.

18. The device according to claim 17, wherein the input data is data of an image, the trained model is one of: an image classification model, a semantic segmentation model and a target recognition model, and the prediction result is a corresponding one of: an image classification result, a semantic segmentation result and a target recognition result.
